(19) United States
(12) Patent Application Publication
(10) Pub. No.: US 2024/0138616 A1
(43) Pub. Date: May 2, 2024

(54) GRILL PAN

(71) Applicant: HAJATEC HOLDING AG, Zug (CH)

(72) Inventor: Hartmut JABS, Zug (CH)

(21) Appl. No.: 18/279,642

(22) PCT Filed: Mar. 1, 2022
(86) PCT No.: PCT/EP2022/055193

§ 371 Date: Sep. 1, 2023

(30) Foreign Application Priority Data
Mar. 3, 2021 (DE) 10 2021 105 168.1

(51) Int. Cl. A47J 36/20; A23B 4/052; A47J 36/02; A47J 37/07; A47J 37/10

(52) U.S. Cl. CPC A47J 36/20; A23B 4/052; A47J 36/02; A47J 37/0763; A47J 37/0786; A47J 37/108; A47J 2037/0795

(57) ABSTRACT

The description relates to a grill insert (10) for a pan (1). The grill insert comprises a thermally conductive material and is designed to be arranged in the pan (1). A method for preparing food with the grill insert comprises annealing grilled charcoal with a predetermined maximum size, arranging the grill insert (10) in the pan (1), wherein support sections (12) of the grill insert come into contact with the pan base (2), filling openings between bars of the grill insert (10) with the annealed grilled charcoal, and arranging barbeque goods on the grill insert and grilling the barbeque goods.

The present description relates to a grill insert for frying-pans and to methods for barbequing and smoking in frying-pans.

Barbequing with charcoal imparts a unique aroma to the food to be grilled. Other barbequing methods do not achieve this aroma.

There are a large number of barbequing devices for barbequing with charcoal. The charcoal, usually charcoal or briquettes, is usually positioned under a grill and annealed. The food to be grilled is then arranged on a grid above the charcoal. Many different variations for a corresponding grids are known. For example, the grid can be designed such that a dripping of fat from the food to be grilled onto the embering charcoal is avoided or at least limited.

The charcoal is usually arranged in a dish, wherein different devices and arrangements are known for supply of oxygen.

Another method for aromatizing food to be grilled is smoking. Various methods and special smoking devices are also available for this purpose.

The known barbequing devices or smoking devices are designed for outdoor use or require a corresponding extraction of exhaust air in closed spaces. In addition, known barbequing devices require separate space.

There is therefore a need for improved barbequing devices and barbequing methods. There is also a need for improved smokers and smoking methods.

### SUMMARY OF THE INVENTION

The invention relates to a grill insert, a barbequing device and a method according to the independent claims. Advantageous embodiments are specified in the dependent claims.

In one aspect, a grill insert for a pan is described. The grill insert is formed from a thermally conductive material and is designed to be arranged in the pan. The grill insert comprises a grille, which has a support for barbeque goods and a pan section, wherein the pan section has a support section, which is designed to come into contact with a pan base when arranged in the pan. The grille defines intermediate spaces, which are designed to receive charcoal or other aromatizing materials.

In a further aspect, a barbequing device or a barbequing combination for use on a stove is described. The barbequing device or the barbequing combination consists of a pan and a grill insert, wherein the shape of the grill insert substantially corresponds to the inner shape of the pan. The grill insert is formed from a thermally conductive material and is designed to be arranged in the pan. The grill insert comprises a grille, which has a support for barbeque goods and a pan section, wherein the pan section has a support section, which is designed to come into contact with a pan base when arranged in the pan.

In a further aspect, a method for preparing food is described. The method comprises the steps of lighting-up charcoal with a predetermined maximum size, arranging the grill insert in the pan, wherein support sections of the grill insert come into contact with the pan base, filling openings between bars of the grill insert with the lit-up charcoal, arranging and grilling barbeque goods on the grill insert.

Further aspects, embodiments and optional features result from the dependent claims and the description of examples of the invention.

### DESCRIPTION OF FIGURES

The invention will become clearer upon reading the following description, which is made with reference to the figures, which show:

FIGS. 1 a and 1 b an example of a pan with an inserted grill insert;

FIGS. 2 a, 2 b and 2 c a grill insert according to the description in different views;

FIGS. 3 a and 3 b a plan view and a sectional view of the grill insert inserted into a pan;

FIG. 4 a cross section through a pan with a grill insert in use;

FIG. 5 a further example of a pan;

FIGS. 6 a and 6 b an extension by an adjustable grill on the pan of FIG. 5;

FIGS. 7 and 8 the support and the grill of FIG. 6 in detail;

FIGS. 9 a to 9 c show an example of a pan with a grill insert with additional ventilation;

FIGS. 10 a and 10 b show a grill insert with additional ventilation device; and

FIGS. 11 a and 11 b show a further grill insert with additional ventilation device.

### DETAILED DESCRIPTION

In the following detailed description of the invention, examples are given which show aspects and implementations of the invention by way of example and which are not limiting in any way. It is not necessary to use all features shown with reference to one or more examples to implement the invention. Rather, a person skilled in the art will recognize that various features can be omitted or replaced by others without departing from the invention.

The present disclosure describes a grill insert for a pan. The grill insert is formed from a thermally conductive material and is designed to be arranged in the pan. The thermally conductive material can be a cast iron or an alloy of cast material. The grill insert can be formed entirely from the thermally conductive material. However, addional parts made of a different material can also be provided.

The grill insert comprises a grill, which can be designed as a grid. The grill has a support for barbeque goods and a pan section, wherein the pan section has a support section, which is designed to come into contact with a pan base when arranged in the pan. The support section has a largest possible surface area, by which the support section can come into direct contact with the base of a pan, so that a heat exchange to the grille and the base section is ensured.

The grille has openings, which can also be referred to as intermediate grille openings. In other words, the grille defines intermediate spaces or intermediate grille volumes. The openings or gaps are designed to receive charcoal or other aromatizing materials. The openings can be depressions in the grill insert. The openings can also have the shape of through openings. The openings then provide access to the pan base. The shape of the openings can differ. For example, bore holes with a predetermined diameter can be provided. The openings can also be square-shaped, rectangular, oval or any other shape. The grill is inherently stable. The gaps are advantageously open downward, so that the heat can pass directly from the pan base into the gaps. In this example, the grill insert has no base, at least no continuous base.

In one example, the grille can have a plurality of bars or be formed from these. The bars can extend in the vertical direction from the support section of the pan section to the support for barbeque goods. The bars are formed from the thermally conductive material and provide good heat transport from the heated pan base to the support for barbeque goods. A direct heat transport from the pan base via the support section to the barbeque goods on the support for barbeque goods can thus take place. In addition, the side walls of the bars have a large surface area, which can absorb the heat from the charcoal and transfer it to the support for barbeque goods.

A first set of the plurality of bars can be arranged parallel to one another at uniform distances and can extend in a first direction. A second set of the plurality of bars can extend in a second direction, which can be arranged orthogonally to the first direction. The bars of the second set of bars can likewise be arranged at uniform distances from one another. If the distances in the first and in the second direction are the same, square openings result between the orthogonally arranged bars. If a different distance is selected in the second direction than in the first direction, rectangular openings result. If the first direction is not orthogonal, but is arranged at an angle different from 90° to the second direction, a diamond-shaped opening or an opening in the shape of a parallelogram results. The shape of the opening can be adapted to the function, wherein a square shape has proven functionally successful. However, other geometries of the bars can also be provided, e.g., in order to correspondingly brand the barbecue.

The width of the opening is adapted to the charcoal and the barbecue. Excessively wide distances allow the barbecue to sag or slip into the openings. Excessively small or narrow openings allow only the reception of small pieces of charcoal, which anneal relatively quickly. In practice, a distance of 1 to 3 cm between the bars has proven successful.

The charcoal can be specially adapted for the openings. For example, briquettes can be provided, the dimension of which corresponds to the opening width, or is somewhat smaller, so that the glowing pieces of charcoal can be filled well into the openings.

The term charcoal here stands for lump charcoal, briquettes or other forms of charcoal, which is suitable for the barbecue of food. Instead of charcoal, wood chips can also be used for aromatizing.

The bars can taper from the pan section to the support for barbeque goods. This results in a large support surface and good heat development and radiation from the charcoal to the barbecue. The filling of the glowing charcoal into the openings between the bars is likewise facilitated.

The tapering of the bars can be continuous or take place in one or more steps.

The grill insert can additionally comprise a circumferential and closed side edge. The side edge is not absolutely necessary, but can hold the charcoal within the grill insert. The side wall can also facilitate the positioning of the grill insert in the pan and prevent scratching of the bars on the inner side of the pan. For example, a circumference of the edge on the pan section can be smaller than a circumference of the edge on the support for barbeque goods.

The present disclosure also relates to a set or a system comprising a pan and a grill insert. The shape of the grill insert is, for example, substantially correspondingly adapted to the inner shape of the pan. The pan can also be adapted to the shape of the grill insert. The grill insert and the pan are specially matched to one another in this example. The heat transfer can thus be further improved.

The pan can comprise a receptacle for a cocking grill. The cocking grill can be used additionally or alternatively to the grill insert. The height of the cocking grill can be adjustable. The distance from the cocking grill to the pan base and thus to the heat source can thus be adjustable. The grill can also be pivotable.

The present disclosure also describes a method for grilling barbeque goods or more generally for preparing food. The method comprises the steps of lighting-up of charcoal with a predetermined maximum size, arranging the grill insert in the pan, wherein support sections of the grill insert come into contact with the pan base, filling openings between bars of the grill insert with the lit-up charcoal, and arranging barbeque goods on the grill insert and grilling the barbeque goods with the grill insert arranged in the pan.

The charcoal can be conventional lump charcoal or charcoal briquettes. Alternatively, charcoal specially adapted for the grill insert can also be used. The charcoal can then be distributed particularly easily into the openings. The grid insert can therefore also be referred to as grill insert.

Before the filling of the openings with the lit charcoal, the pan can be heated on the stove, so that it already has a very high basic heat. The grill insert can also already be in the pan during the heating of the pan and be heated as well. Thus, after the filling of the charcoal, the grilling temperature is reached very quickly and less charcoal is required. The grilling process can be started directly after the filling.

The stove can be a conventional gas, electric or induction stove. The grill insert and the method can be used with professional stoves, but also with domestic stoves. Any other type of stove or heating plate can also be provided. The stove fosters the grilling, but the temperature required for the grilling and the aroma is provided by the charcoal. With the stove, the heat supply can also be regulated during the grilling.

The grilling can be followed by simmering. During the simmering, the food to be grilled is arranged on a cooking grill attached to the pan. The simmering temperature can be adapted with a height adjustment of the cooking grill and with the temperature regulation of the stove. With a pivotable cooking grill, the food to be grilled can then be pivoted away from the heat source and brought into a rest position.

In addition to or in addition to the grilling with the grill insert, this can also be used as a smoker. Instead of charcoal, incandescent or glowing wood chips, for example beech wood or another aromatic wood or other substances, can be used here. The chips are then placed in the openings of the grill insert and the food to be grilled to be smoked is placed on. The smoking process can be controlled by means of the temperature regulation on the stove. The smoking can be applied separately or in conjunction with the grilling described.

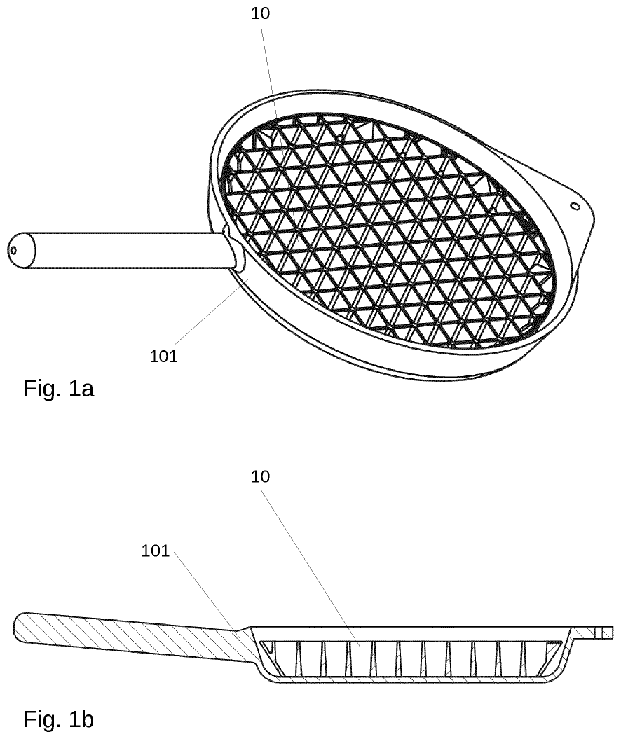

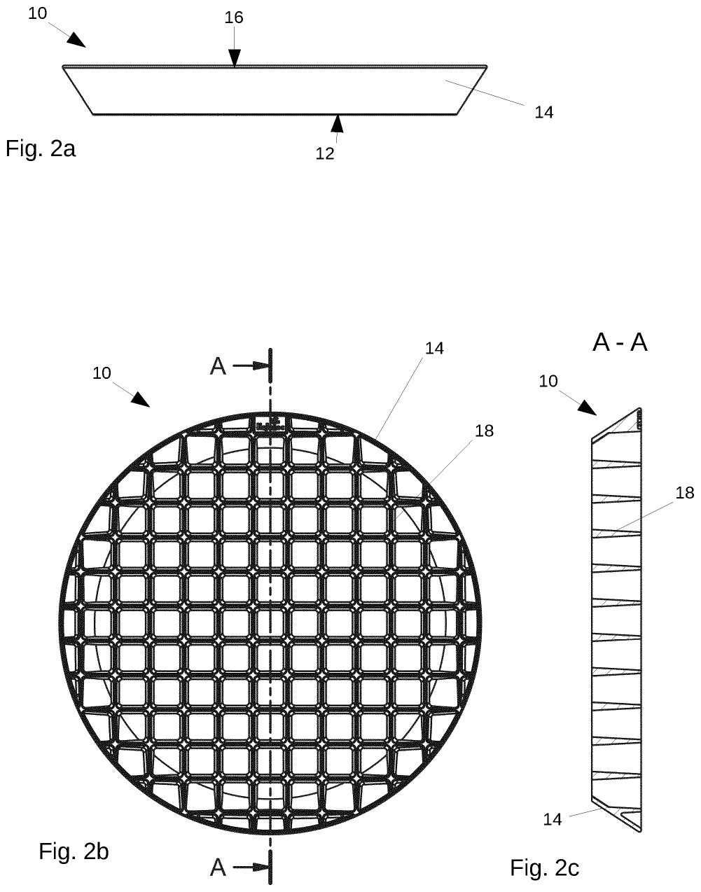

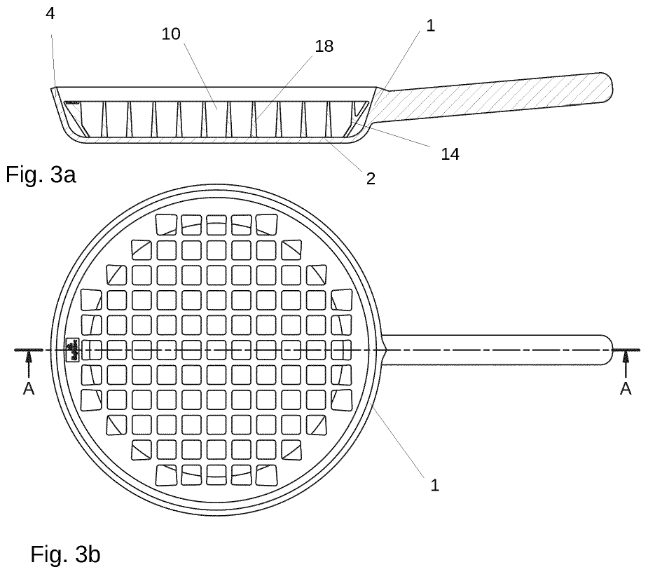

Examples of the invention are described below with reference to the accompanying figures. FIG. 1 a shows an example of an application of a grid insert 10 in a pan 101. The grid insert 10 is also referred to below as grill insert 10. The pan 101 can be a commercially available frying pan, but the pan 101 can also be specially adapted or designed for the grid insert 10. It is advantageous if the pan is made of a material with high heat capacity and good thermal conductivity. Pans made of cast iron have proven successful in this context. In the example of FIG. 1 a, a grid insert 10 is already arranged inside the pan. FIG. 1 b shows a cross section through the pan 101 with an inserted grid insert 10. The grid insert 10 is described in more detail below with reference to FIGS. 2 and 3.

FIG. 2 shows the grid insert 10 of FIG. 1 in different views. FIG. 2 b shows a plan view of the grid insert 10 from above. The grid insert 10 has a grill with a grid structure of supports for barbeque goods. In the example shown, the grid is arranged regularly. A plurality of uniformly spaced parallel bars 18 is arranged orthogonally to a second set of parallel bars, likewise arranged at the same distance, in order to form the grid. In the example shown, the bars 18 are fixedly connected to one another at the crossing points, so that the grid becomes inherently fixed and stable. The grid is self-supporting. Square openings result between the crossing bars 18. The intermediate grille volume, here in the form of the square openings, has, for example, a width of approximately 1 to 3 cm, preferably 1.5 to 2.5 cm. The openings are designed to receive glowing pieces of charcoal in the openings. Preformed pieces of charcoal can be specially adapted to the openings. The openings can also be larger or smaller, but excessively wide openings are not suitable for holding barbeque goods. If the openings are too small, they can only receive very small pieces of charcoal, which light-up quickly. While square openings are provided in the example shown, the openings can have other shapes, for example rectangles, diamonds or parallelograms, depending on the embodiment of the bars.

The pieces of charcoal can be pieces of lump charcoal. In one example, particularly small pieces of charcoal can be used. In order to fill the intermediate grid volume or the openings with pieces of charcoal in the best possible manner, charcoal briquettes or charcoal pellets can be used. These briquettes or pellets can be pressed into a shape and size, so that they can be introduced well into the intermediate grid openings. Charcoal briquettes or charcoal pellets are advantageous for the barbeque-typical taste, since the typical barbeque aroma is achieved in particular thereby. In addition to charcoal, a binder can also additionally be provided in the pieces of charcoal, in order to shape and hold the charcoal.

In the example shown, the grid is outwardly limited by a circumferential side wall 14, which is shown in a side view in FIG. 2 a. The circumferential side wall 14 of the illustrated grid insert 10 has the shape of a shell of a truncated cone, which tapers downward. The grid insert 10 can thereby be easily inserted into a pan. The grid insert is easily and quickly correctly positioned, which is advantageous in particular in gastronomy. Damage to a pan is thereby also avoided. The tapering can be adapted to the pan. The grid insert has a bottom side 12, which is substantially planar. When the grid insert is arranged in a pan, the bottom side comes into contact with the pan base. A good heat transfer between the pan base and the grid insert is thereby ensured.

FIG. 2 c shows a sectional view through the grid insert 10 of FIG. 2 b along the axis A-A. It can be seen that the bars 18 are arranged at uniform distances from one another. The bars 18 taper from the bottom side 12 to the grill side 16. In this example, the bars 18 taper continuously. A wider support on the pan base and a better heat exchange with the pan base 2 thus results.

FIG. 3 shows a grid insert 10 from FIG. 2 in a commercially available pan 1, in FIG. 3 b in a plan view and in FIG. 3 a in a sectional view along the axis A-A of FIG. 3 b. As can be seen in FIG. 3 a, the bars 18 come into contact with the pan base 2, so that the heat can be transferred directly. In the example shown, the grid insert 10 has a lower height than the pan edge 4. Food to be grilled on the grill insert can thus be secured laterally by the pan edge 4. However, the grill insert may be flush with the pan edge or projects upwards beyond the latter.

The pan can be placed with the grid insert 10 on a stove and be heated by the stove. The stove can be a gas stove, an electric stove, an induction stove or any other stove.

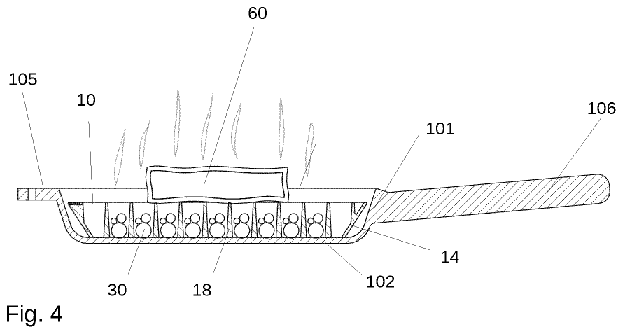

For grilling, charcoal is first brought to glow. For this purpose, for example, conventional electric charcoal ignition devices or other known methods can be used. In parallel, the pan with the inserted grill insert can be heated on the stove. The pan and the grill then already have a basic heat. This basic heat can be, depending on the stove, approximately 200° C. to 250° C. The glowing pieces of charcoal 30 are then distributed onto the heated grid and distributed in the intermediate grid openings between the bars 18. A spatula or another tool can be used in order to distribute the pieces of charcoal into the intermediate grid openings. The grilled state with the pieces of charcoal 30 in the intermediate grid openings is shown by way of example in FIG. 4. For this purpose, it is advantageous to use pieces of charcoal which are adapted in their dimensions to the openings, i.e. which are small enough so that they can be received in the openings. By means of the additional heat of the charcoal, the required temperature for grilling above 300° C., for example approximately 310 to 320° C. is usually reached quickly and the barbeque goods 60 can be placed on the grill insert 10 in the pan 1, 101, as shown in FIG. 4. The grilling process starts. The stove can remain switched on or can be regulated as desired. Between the bars 18 of the grid insert 10, the charcoal receives only a small supply of oxygen or no supply of oxygen at all. The ember glows sloly. By means of the supporting heat of the stove, an optimum grilling temperature is nevertheless reached and a dry heat is produced.

Barbeque food with the typical charcoal aroma can thus be grilled on each stove by use of the grid insert 10. The grill can be operated under a conventional steam extraction and is thus suitable for any kitchen, in particular also in gastronomy. By means of the separate lighting device, the pan can remain on the stove only for the grilling time and for a heating time of the pan. After this and before this, the stove is available for other activities, which enables a space-saving application in gastronomy even in cramped conditions. A separate grill is no longer necessary and the grilling is also readily possible in closed kitchens.

In addition to the above-described grilling process, it is also possible to use the grill insert for smoking, for example with wood chips. The wood chips are arranged instead of the pieces of charcoal in the intermediate grille openings of the grill or grill insert and the pan is heated. The food to be grilled is placed on and aromatized gently by the heated chips. The aromatization process can be controlled by means of the stove temperature. The chips can be brought to ember or glow. Conventional wood chips made of beech wood or another aromatizing wood can be used. The smoking process can likewise be regulated via the heat regulation of the stove.

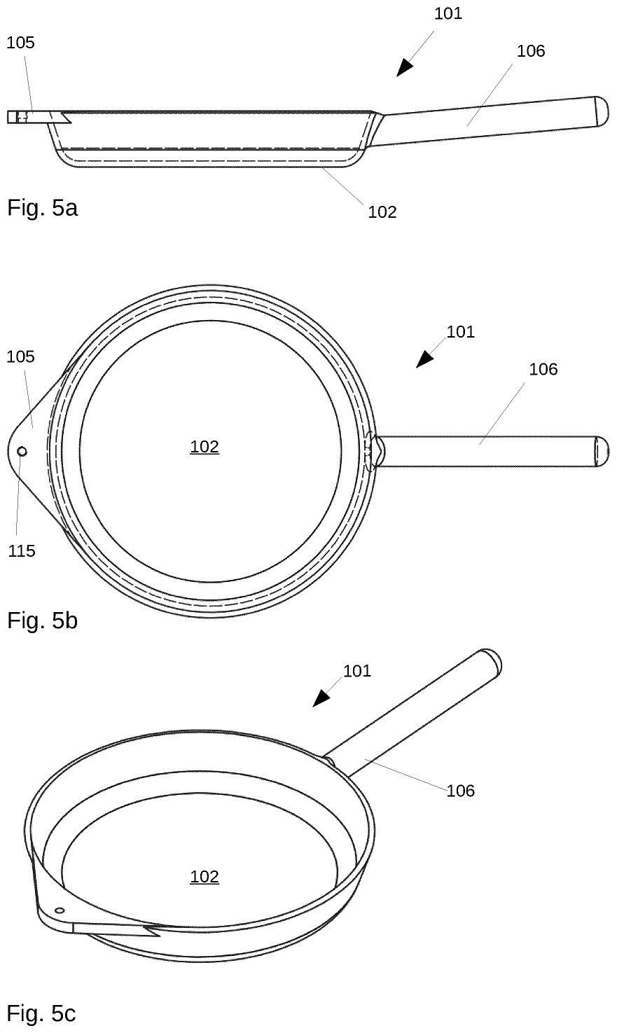

The pan 101 used in FIG. 4 differs from the pan 1 of FIGS. 2 to 3 by an additional receptacle 105, which is arranged opposite the handle 106. The pan 101 with the receptacle 105 is shown in FIG. 5 in different views without a grill and other additional parts, in FIG. 5 a in a sectional view, in FIG. 5 b in the plan view and in FIG. 5 c in an oblique view. Apart from the receptacle 105, the pan does not differ from the pan of FIGS. 1 to 3 without receptacles. The receptacle 105 has a receiving bore 115.

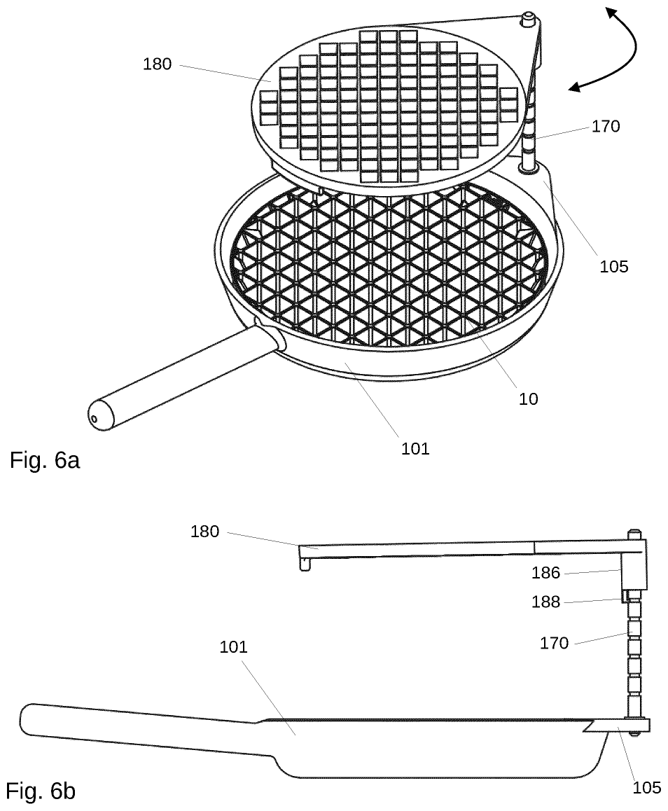

FIGS. 6 a and 6 b show the pan 101 of FIG. 5 with an inserted grill 10 and a carrier rod 170 and cocking grid 180 additionally inserted into the receptacle 105. FIG. 6 a shows an oblique view and FIG. 6 b a side view. The grid insert 10 corresponds to the above-described grid insert 10, here inserted into the pan 101. The carrier rod 170 has a cylindrical basic shape, wherein a first end 175 is inserted into the receiving bore 115. The carrier rod is designed to be seated in the receiving bore 115 and to carry the cocking grid 180. The height of the grid 180 is adjustable. For this purpose, it can be adjusted on the carrier rod in different positions or continuously. In FIGS. 6 a and 6 b, the grill is shown in each case in the highest position in which the grill has the greatest distance from the grill insert. The height adjustment enables a good temperature adaptation when the food to be grilled is placed on the cocking grid 180 for cooking or simmering. The cocking grid 180 is furthermore mounted rotatably about the axis of the carrier rod 170, so that the cocking grid 180 can be rotated over the pan 101 and away from the pan 101. The barbeques food, in particular meat, can then be pivoted away from the heat source for rest after the cooking to rest there. It is not necessary to take the barbeque food away from the grid. With this arrangement, all steps of grilling, in particular of red meat, can take place with a pan without large space requirement. The entire grilling process, including cooking and rest, can take place substantially on a single cooking point.

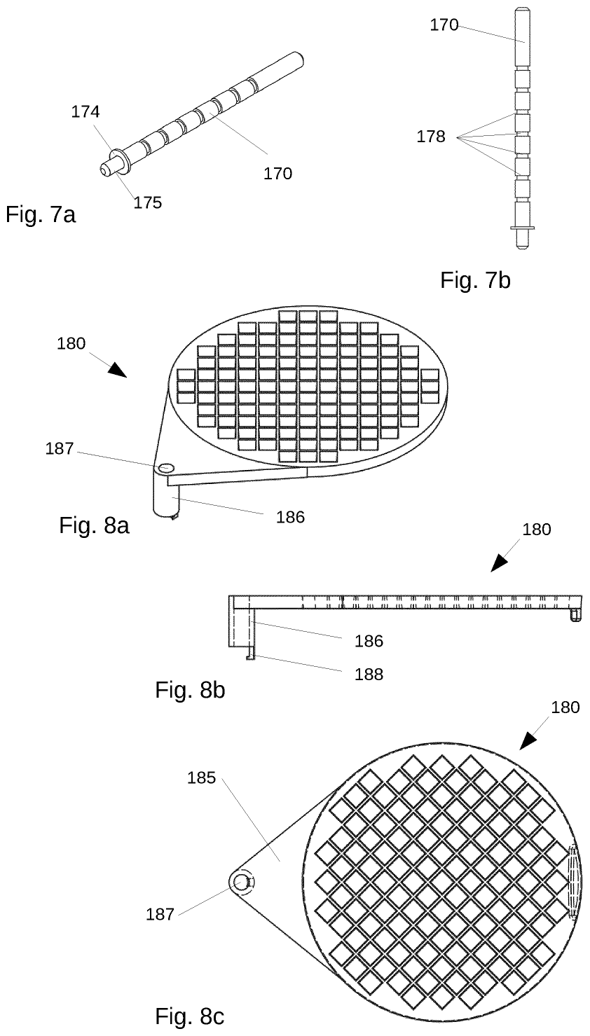

The carrier rod is shown separately in FIGS. 7 a and 7 b. The diameter and the surface area of the first end 175 is adapted to the receiving bore, so that the carrier rod 170 is received substantially without play, but movably. A stop 174 on the carrier rod 170 can be provided as a limitation in order to prevent the carrier rod from slipping through. In the example shown, the carrier rod also has a plurality of grooves 178 in which a latching lug 188 of the cocking grid 180 can engage, as shown in FIG. 6 b for an exemplary height. By means of the inherent weight of the cocking grid 180, a secure height locking is achieved with simultaneous rotatability. In another embodiment, a cylindrical rod can also be provided and the height locking takes place by tilting or tilting the grill. This enables a stepless height adjustment.

The cocking grid 180 is shown separately in FIGS. 8 a, 8 b and 8 c, wherein FIG. 8 a shows an oblique view, FIG. 8 b a sectional view and FIG. 8 c a plan view. The cocking grid 180 has a grid area with a grille. As in the example shown, the grid area can have a circular circumference. The grille of the grid areas can have bars arranged parallel to one another and/or struts arranged perpendicular to one another. The shape of the grid can have different shapes and designs, which are suitable for supporting the food to be grilled. On one side of the grid area, the cocking grid 180 has a support region 185 with a bore 187. Here, the bore is designed as a through-hole and has a width adapted to the carrier rod 170, so that the cocking grid 180 can slide along the carrier rod 170 and be adjusted in height. The cocking grid 180 can therefore also be arranged rotatably about the axis of the carrier rod 170. On the support region 185, a support 186 is provided, through which the bore 187 is formed. The support can have the shape of a pipe piece, as shown in FIG. 8. However, other shapes are also possible. The support increases the stability and simultaneously improves the locking in height when the bore 187 tilts with respect to the carrier rod. As a result, a stepless height adjustment can be achieved. For better safety, the latching lug 188 can additionally be provided, which engages in the carrier rod 178 and the grooves when the cocking grid 180 tilts. A stable height grid is therefore achieved. Other lockings can likewise be used here.

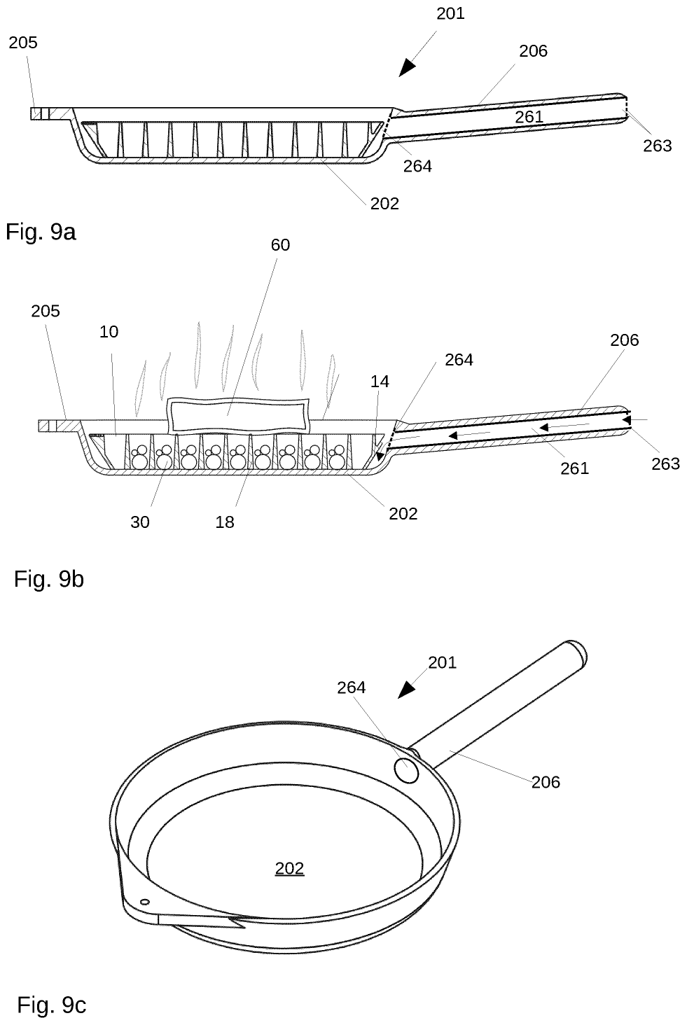

further example is shown in FIG. 9. The pan 201 in this example substantially corresponds to the pan 101 of the preceding figures with an inserted grid insert 10, wherein an air vent device is additionally provided. The air vent device is arranged in the handle 206 of the pan in this example. The handle 206 is designed as a tube, which has openings at both ends. An air channel 261 is thereby produced, which enables fresh air to be guided from outside to the charcoal. For this purpose, the handle has an inlet opening 263 at the first end and a second opening as an air inlet 264 into the inside of the pan. FIG. 9 a shows the pan 201 in section, FIG. 9 b shows the pan 201 in use, wherein fresh air, as shown by means of the arrows, is guided through the air channel 261 to the pieces of charcoal 30. FIG. 9 c shows an oblique view of the pan of FIGS. 9 a and 9 b, but without a grill insert 10. The air inlet 264 can be seen.

In a further example, the handle for ventilation can also be removable, for example by means of a screw connection.

In addition or alternatively to the ventilation by the handle, ventilation pipes can also be attached at one or more points of the pan side wall. These can be arranged fixedly, for example by means of a welded connection, or removably, for example by means of a screw connection, on the pan side wall. A supply of fresh air to the charcoal or the wood chips can therefore be achieved, and can also be achieved from a plurality of sides.

The use of ventilation channels enables fresh air to be guided from outside the stove to the charcoal, while at the same time the pan and therefore the grill insert can additionally be heated on a gas stove.

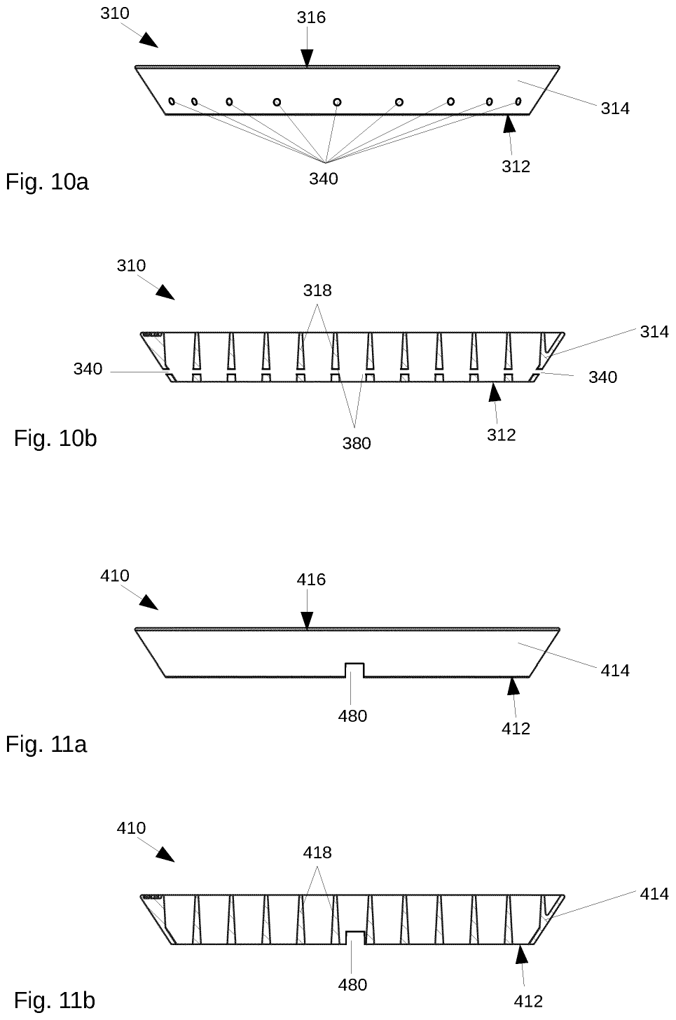

As an alternative or in addition to the ventilation of the pan, the grill insert can also have an air vent device, as shown in FIG. 10. The grid insert 310 shown in this example corresponds to the grid insert 10 of the preceding examples, wherein a plurality of side wall openings 340 are additionally provided here in the side wall 314. In the example shown, these are designed as bore holes, as can be seen in FIG. 10 a. The side wall openings are designed here circumferentially around the side wall 314 in order to enable a uniform air supply. However, a different arrangement can also be selected. The side wall openings can also have a different shape or size.

In addition to in the side wall openings 340, the grid insert 310 also has intermediate chamber or bar openings 380 in the bars 318, which are shown in the section of FIG. 10 b. The bar openings 380 allow an air exchange between the individual intermediate grid volumes or coal receptacles. A uniform glow can therefore be achieved. The bar openings can be designed as a round bore or as other openings.

In FIGS. 10 a and 10 b, the bar openings 380 in the bar walls 318 and the side wall openings 340 in the side wall 314 are each shown as holes. This is an advantageous embodiment.

In another example shown in FIG. 11, the air vent device can have bar openings or recesses 480 provided directly on the bottom side 412. The recesses are designed corresponding to a groove in the grill insert. This can be produced more easily, for example by milling or directly during casting. In FIGS. 11 a and 11 b, only one recess 480 is shown here, but a plurality of recesses can also be provided. The recesses 480 can, for example, be arranged such that they correspond to the ventilation channels in a pan, as described above.

In another example (not shown), the air vent device can also be designed by means of support elements or columns, which can be arranged on the bottom side of the bars and hold the grill insert. When the grill insert is inserted into a pan, the support elements contact the pan base and hold the bottom side of the grill insert at a distance from the pan base. Air can be guided under the bottom side between the support elements to the charcoal or the chips in the intermediate grille volume. The number of support elements can be selected such that the thermal contact with the pan base enables a sufficient heating of the bars and a uniform air supply is achieved. Fewer, larger support elements can also be provided. The support elements can be made of the same material as the bars.

A first example comprises a method for grilling barbeque goods.

The method comprises:
annealing grilled charcoal with a predetermined maximum size,
arranging a grill insert 10 in the pan 1, 101; wherein support sections 12 of the grill insert 10 come into contact with the pan base 2, 102,
filling openings between bars 18 of the grill insert 10 with the annealed grilled charcoal 30, and
arranging barbeque goods (60) on the grill insert and grilling the barbeque goods.

A second example comprises a method for smoking food.

The method comprises:
arranging a grill insert 10 in the pan 1, 101; wherein support sections 12 of the grill insert 10 come into contact with the pan base 2, 102,
filling openings between bars 18 of the grill insert 10 with aromatizing material, heating the pan and
arranging food to be aromatized on the grill insert and smoking the food.

Example 3. The method according to example 2, wherein the aromatizing material comprises wood chips.

Example 4. The method according to example 2 or 3, further comprising heating the aromatizing material before filling the openings.

The preceding description relates to examples of possible embodiments of the invention. It is not necessary to use all features of the description. A grill insert according to the description without a pan, for example directly on a heating plate or on another element, can also be used. Other applications and variations, which can also comprise omitting features, are likewise possible within the scope of the present description.

1. Grill insert for a pan,
wherein the grill insert is formed from a thermally conductive material and is designed to be arranged in the pan,
wherein the grill insert comprises a grille, which has a support for barbeque goods and a pan section, and wherein the pan section has a support section, which is designed to come into contact with a pan base when arranged in the pan, wherein the grille defines intermediate spaces, which are designed to receive charcoal or other aromatizing materials.

2. Grill insert according to claim 1, wherein the grille has a plurality of bars, which extend from the support section of the pan section to the support for barbeque goods.

3. Grill insert according to claim 2, wherein the bars define openings, which can receive charcoal.

4. Grill insert according to claim 2, wherein the bars taper from the pan section to the support for barbeque goods.

5. Grill insert according to claim 1, wherein the thermally conductive material is a cast metal alloy.

6. Grill insert according to claim 1, additionally comprising a circumferential closed edge, wherein a circumference of the edge on the pan section is smaller than a circumference of the on the support for barbeque goods.

7. Grill insert according to claim 1, additionally comprising an air vent device on the pan section.

8. Grill insert according to claim 7, wherein the air vent device comprises at least one of recesses and support elements.

9. Barbequing device for use on a stove, comprising:
a pan; and
a grill insert,
wherein the grill insert is formed from a thermally conductive material and is designed to be arranged in the pan,
wherein the grill insert comprises a grille, which has a support for barbeque goods and a pan section, and wherein the pan section has a support section, which is designed to come into contact with a pan base when arranged in the pan, wherein the grille defines intermediate spaces, which are designed to receive charcoal or other aromatizing materials, and
wherein the shape of the grill insert substantially corresponds to the inner shape of the pan.

10. Barbequing device according to claim 9, additionally comprising a cocking grid, which can be reversibly arranged on the pan.

11. Barbequing device according to claim 10, wherein the distance of the cocking grid to the pan is adjustable.

12. Barbequing device according to claim 10, wherein the cocking grid is pivotable with respect to the pan.

13. Method for preparing food, the method comprising:
Lighting-up charcoal of a predetermined maximum size,
arranging a grill insert in a pan; wherein support sections of the grill insert come into contact with the pan base,
filling openings between bars of the grill insert with the lit-up charcoal, and
arranging barbeque goods on the grill insert and grilling the barbeque goods.

14. The method according to claim 13, further comprising heating the pan on a stove before filling the openings with the lit-up charcoal.

15. The method according to claim 13, further comprising heating the pan with a stove during the grilling.

16. The method according to claim 13, further comprising smoking the barbeque goods before filling the openings with charcoal, comprising arranging aromatizing material in the openings of the grill insert and heating the grill insert with the stove.

17. The method according to claim 13, wherein the lighting-up comprises electric lighting-up.

18. The method according to claim 13, further comprising simmering the barbeque goods on a cooking grill attached to the pan.
